(19) United States
(12) Patent Application Publication
(10) Pub. No.: US 2014/0358996 A1
(43) Pub. Date: Dec. 4, 2014

(54) DISTRIBUTED ENCODING AND DECODING SYSTEM, METHOD, AND DEVICE

(71) Applicant: HON HAI PRECISION INDUSTRY CO., LTD., New Taipei (TW)

(72) Inventors: LEE-FAN CHANG, New Taipei (TW); CHUNG-I LEE, New Taipei (TW)

(73) Assignee: HON HAI PRECISION INDUSTRY CO., LTD., New Taipei (TW)

(21) Appl. No.: 14/288,859

(22) Filed: May 28, 2014

(30) Foreign Application Priority Data
May 30, 2013 (TW) 102119034

(51) Int. Cl. H04L 29/06

(52) U.S. Cl. CPC H04L 67/42
USPC 709/203

(57) ABSTRACT

In a distributed encoding and decoding method, a destination file is requested from a master server by a client device, and the master server selects source servers that store the destination file or segments thereof. The master server further computes priorities of the source servers, and selects encoding servers according to the priorities. The master server segments the destination file in each of the encoding servers into file segments, and distributes the file segments to the encoding servers. Each of the encoding servers encodes one or more distributed file segments, and transmits the file segments to the client device. The client device receives and decodes the file segments and integrates the file segments to generate a complete the destination file.

### CROSS-REFERENCE TO RELATED APPLICATIONS

This application claims priority to Taiwanese Patent Application No. 102119034 filed on May 30, 2013, in the Taiwan Intellectual Property Office, the contents of which are incorporated by reference herein.

### FIELD

The subject matter herein generally relates to data encoding and decoding, and more specifically to a device, a method and a system of distributed encoding and decoding of files.

### BACKGROUND

Video signals often requires a large amount of data storage space and transmission bandwidth. To reduce the data storage space and transmission bandwidth, video compression may be needed.

Video compression involves encoding data using fewer bits than the original representation to generate compressed data. The compressed data must be decoded before use. The encoding and decoding process requires a great amount of computation. Both time and cost efficiency of the encoding and decoding process is important.

### BRIEF DESCRIPTION OF THE DRAWINGS

Implementations of the present technology will now be described, by way of example only, with reference to the attached figures, wherein:

FIG. 1 is a block diagram of one embodiment of a running environment of a distributed encoding and decoding system.

FIG. 2 is a block diagram of one embodiment of hardware architecture for executing the distributed encoding and decoding system.

FIG. 3 is a block diagram of one embodiment of function modules of the distributed encoding and decoding system.

FIG. 4 is an example of a distribution form.

FIG. 5 is a flowchart of one embodiment of a distributed encoding method.

FIG. 6 is a flowchart of one embodiment of a distributed decoding method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

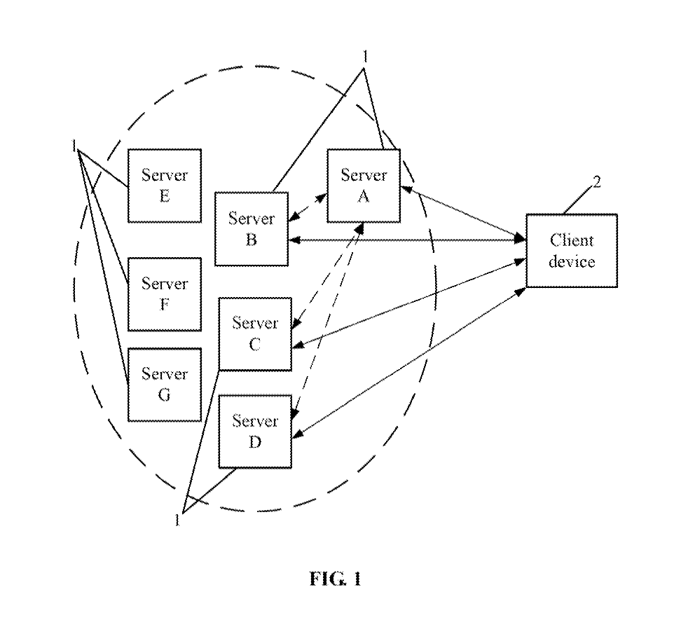

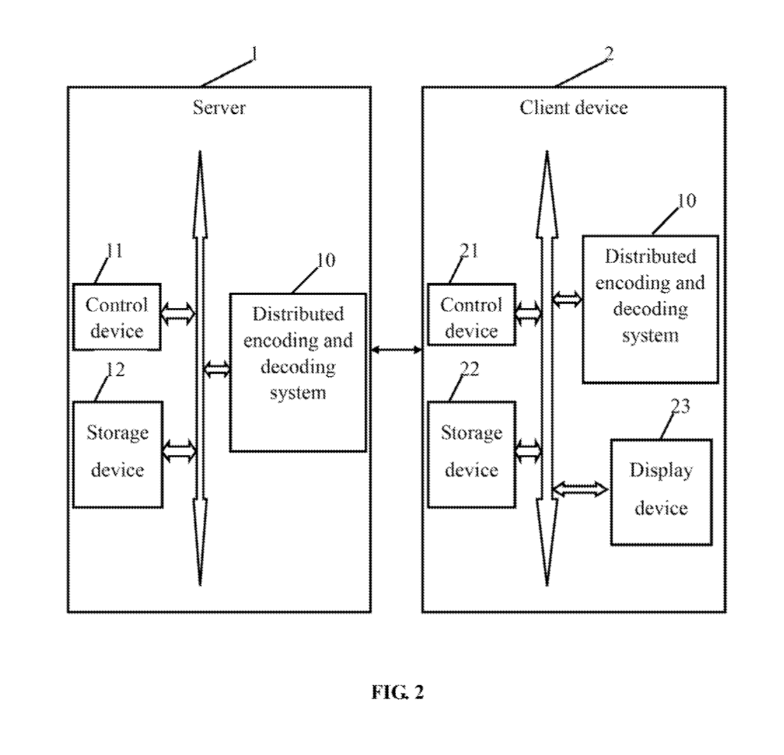

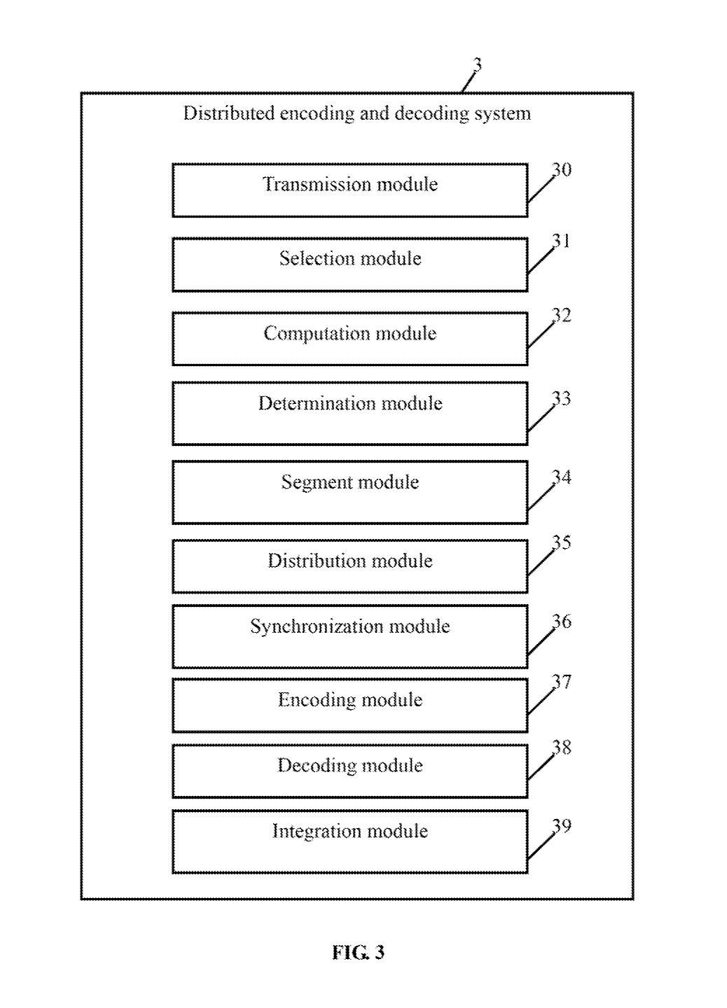

Referring to FIG. 1 to FIG. 3, FIG. 1 is a block diagram of one embodiment of a running environment of a distributed encoding and decoding system, FIG. 2 is a block diagram of one embodiment of a hardware architecture for executing the distributed encoding and decoding system, and FIG. 3 is a block diagram of one embodiment of function modules of the distributed encoding and decoding system.

The distributed encoding and decoding system 10 is installed and run on electronic devices and includes a server cluster including a plurality of servers 1 and a client device 2. The servers 1 and the client device 2 can communicate with each other using networks, such as the Internet, intranets, or any other suitable networks. The servers 1 can be computers or servers, and the client device 2 can be a computer, a smart phone, a smart television, a personal digital assistant (PDA), and any other portable electronic device.

The servers 1 include a master server and a plurality of secondary servers. The master server 1 can be a dedicated server, such as server A in FIG. 1, or an arbitrarily designated server, such as server B, server C, server D, or any other server.

Each of the servers 1 includes a control device 11, a storage device 12, and other necessary components. The client device 2 includes a control device 21, a storage device 22, a display device 23, and other necessary components. The control devices 11 and 21 can be a processor, an application-specific integrated circuit (ASIC), or a field programmable gate array (FPGA), for example. The storage devices 12 and 22 can include some type(s) of non-transitory computer-readable storage medium, for example a hard disk drive, a compact disc, a digital video disc, or a tape drive. The display device 23 of the client device 2 can output data for viewing.

The distributed encoding and decoding system 10 can include a plurality of function modules including a transmission module 30, a selection module 31, a computation module 32, a determination module 33, a segment module 34, a distribution module 35, a synchronization module 36, an encoding module 37, a decoding module 38, and an integration module 39.

The function modules 30-39 of the distributed encoding and decoding system 10 include computerized codes that can be stored in the storage devices 12 and 22. When being executed by the control devices 11 and 21, the function modules 30-39 can perform the functions described below.

The transmission module 30 can perform data transmission between the servers 1 and the client device 2. The data transmission can include a request for a destination file sent from the client device 2 to a master server in the servers 1, and file segments of the destination file that have been encoded sent from the servers 1 to the client device 2. The destination file can be a media file, an image file, a text file, and so on.

The selection module 31 can select one or more servers 1 each of which stores the destination file as source servers 1. In one embodiment, the selection module 31 can select a server 1 which only stores a single file segment of the destination file as one of the source servers 1.

The computation module 32 can compute priorities of the source servers 1. In one embodiment, the computation module 32 can compute a priority of each of the source servers 1 using a formula P=QoS/Overhead, wherein the “P” represents a priority of a source server 1, the “QoS” represents quality parameters of a network that connects the client device 2 and the source server 1, the “Overhead” represents resources that the source server 1 has consumed, and the symbol “/” is a division symbol that represents a division operation between QoS and Overhead. The quality parameters of the network include packets transmitted between source server 1 and the client device 2, network traffic, and/or network speed. The resources that the source server 1 has consumed include a memory usage and/or CPU utilization. For example, when a network speed of a network that connects the client device 2 and a source server 1 is 1.0 Gbps, and the CPU utilization of the source server 1 is 20%, then, the priority of the source server 1 is 1.0/20%=5.

The determination module 33 can select one or more encoding servers 1 from the source servers 1 according to the priorities. For example, when the priorities of five source servers 1 are respectively 7, 5, 3, 6, and 2, the determination module 33 can select the source servers with respective priorities of 7, 5, and 6. In one embodiment, the total number of the selectable encoding servers 1 can be predetermined by a user of the client device 2.

The segment module 34 can segment the destination file in each of the encoding servers 1 into a plurality of file segments. The total number of the file segments can be also determined by the user of the client device 2. In one embodiment, the number of the selectable encoding servers 1 can be greater than the number of the file segments. The segment module 34 can distribute an ID of each of the file segments according to its position in the destination file, and obtain a size of each of the file segments.

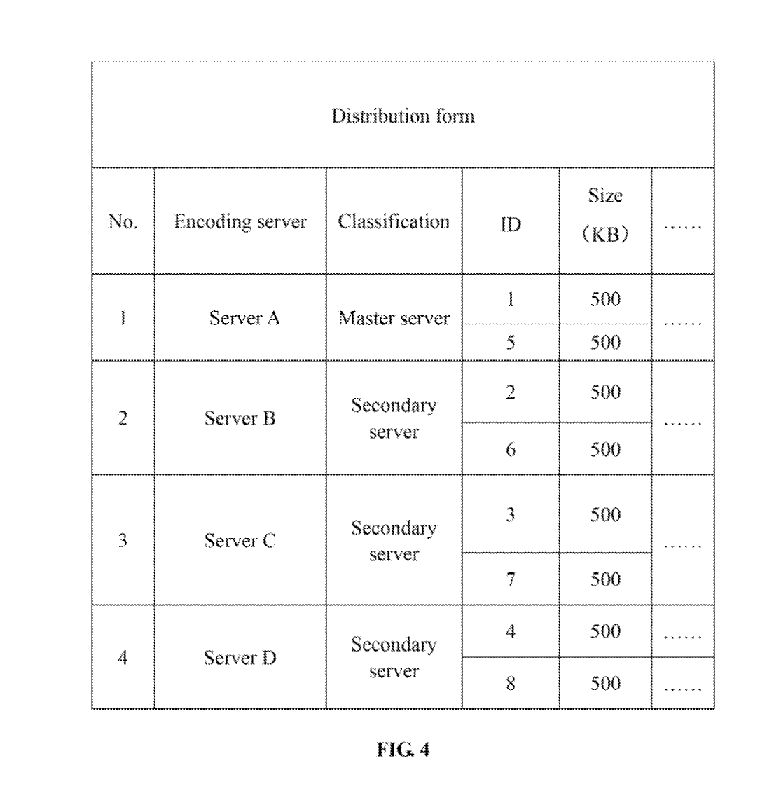

The distribution module 35 can distribute the file segments to the encoding servers 1 according to a predetermined distribution method, and records the distribution, which can include an ID, a size, and a distributed encoding server of each of the file segments. Such recorded distribution information can be inserted into a distribution form, which is illustrated in FIG. 4. The predetermined distribution method can be a Round-Robin method.

The synchronization module 36 can perform synchronization of the distribution form between each of the encoding servers 1 and the client device 2. In one embodiment, the synchronization can be executed once in every period of predetermined periods of time.

The encoding module 37 can perform data encoding to encode one or more distributed file segments. In the embodiment, the distributed file segments can be determined according to the distribution form.

The decoding module 38 can perform data decoding of all of the file segments that have been encoded.

The integration module 39 can integrate the file segments to generate completed destination file according to information in the distribution form. In one embodiment, the integration module 39 integrates the file segments to generate the completed destination file according to the IDs of the file segments. As mentioned above, the IDs indicate respective positions of the file segments in the completed destination file.

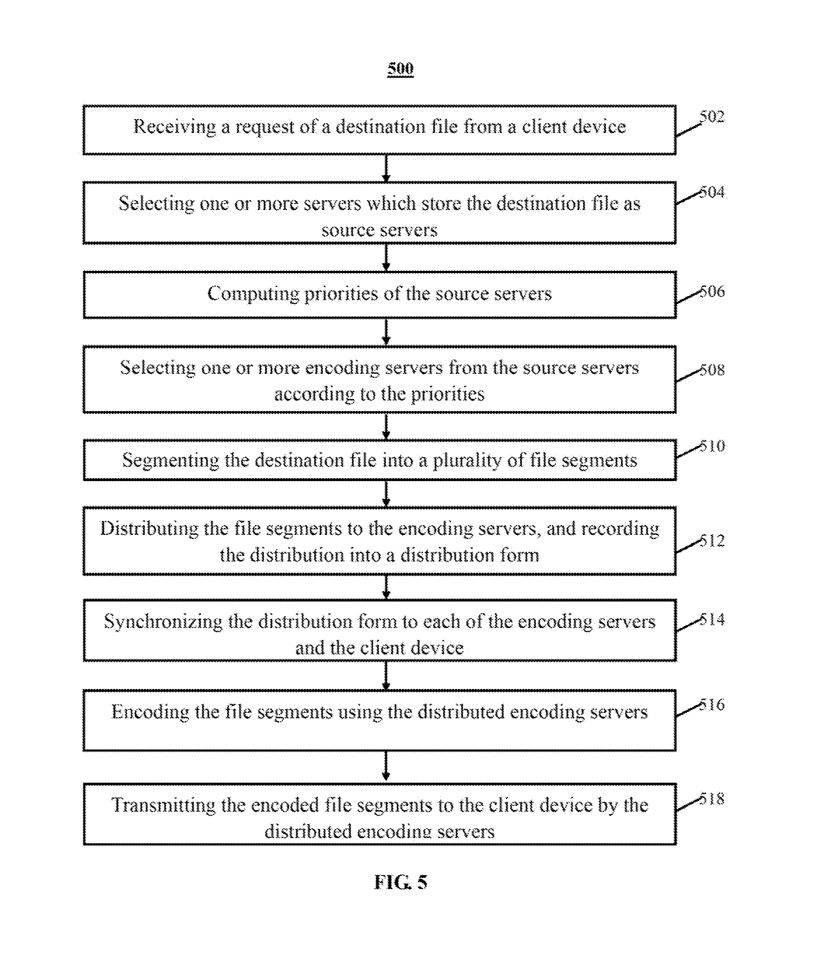

FIG. 5 is a flowchart of one embodiment of a distributed encoding method.

Referring to FIG. 5, a flowchart is presented in accordance with an example embodiment being illustrated. The example method 500 is provided by way of example, as there are a variety of ways to carry out the method. The method 500 described below can be carried out using the configurations illustrated in FIGS. 1 to 3, for example, and various elements of these figures are referenced in explaining example method 500. Each block shown in FIG. 5 represents one or more processes, methods, or subroutines carried out in the exemplary method 500. Additionally, the illustrated order of blocks is by example only and the order of the blocks can change. The exemplary method 500 can begin at block 502.

At block 502, a transmission module in a master server receives a request for a destination file from a client device. The destination file can be a media file, an image file, a text file, and so on.

At block 504, a selection module in the master server selects one or more servers each of which stores the destination file as source servers 1. The servers can include the master server and can communicate with the client device using networks, such as the Internet, intranets, or any other suitable networks. In one embodiment, the source server can store a single file segment of the destination file.

At block 506, a computation module in the master server computes priorities of the source servers. In one embodiment, the computation module can compute a priority of each of the source servers using a formula P=QoS/Overhead, wherein the “P” represents a priority of a source server, the “QoS” represents quality parameters of a network that connects the client device and the source server, the “Overhead” represents resources that the source server has consumed, and the symbol “/” is a division symbol that represents a division operation between QoS and Overhead. The quality parameters of the network can include packets transmitted between source server and the client device, network traffic, and/or network speed. The resources that the source server has consumed can include a memory usage and/or CPU utilization. For example, when a network speed of a network that connects the client device and a source server is 1.0 Gbps, and the CPU utilization of the source server is 20%, then, the priority of the source server 1 is 1.0/20%=5.

At block 508, a determination module in the master server selects one or more encoding servers from the source servers according to the priorities. For example, the respective priorities of five source servers 1 are 7, 5, 3, 6, and 1, and the determination module 33 can select the source servers which have the respective priorities of 7, 5, and 6. In one embodiment, the total number of selectable encoding servers can be predetermined by a user of the client device.

At block 510, a segment module in the master server can segment the destination file in each of the encoding servers into a plurality of file segments. A number of the file segments can be also determined by the user of the client device. In one embodiment, the number of the encoding servers can be greater than the number of the file segments. The segment module can distribute an ID of each of the file segments according to its position in the destination file, and obtain a size of each of the file segments.

At block 512, a distribution module in the master server distributes the file segments to the encoding servers according to a predetermined distribution method, and creates a record of the distribution including an ID, a size, and a distributed encoding server of each of the file segments. The record can be inserted into a distribution form. The distribution form is illustrated in FIG. 4. The predetermined distribution method can be a Round-Robin method.

At block 514, a synchronization module in the master server performs synchronization of the distribution form between each of the encoding servers and the client device. In one embodiment, the synchronization can be executed at predetermined periods of time.

At block 516, an encoding module in each of the encoding servers performs data encoding to encode one or more distributed file segments which are determined according to the distribution form.

At block 518, the transmission module in each of the encoding servers transmits the file segments that have been encoded to the client device. The file segments can be directly transmitted to the client device simultaneously. The file segments can be directly transmitted to the client device according to a predetermined order, such as according to the IDs of the file segments. Otherwise, The file segments can be transmitted to the master server first, and then, the master server transmits all of the file segments to the client device simultaneously or according to a predetermined order.

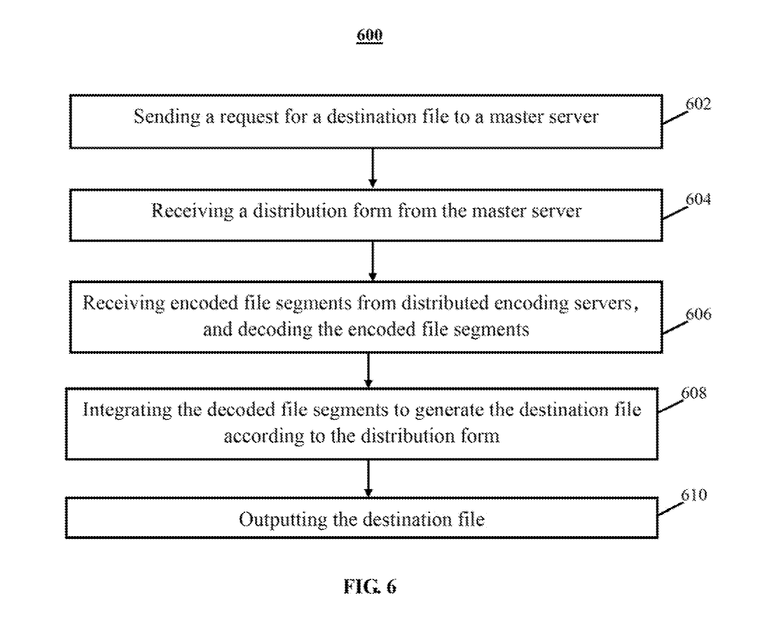

FIG. 6 is a flowchart of one embodiment of a distributed decoding method.

Referring to FIG. 6, a flowchart is presented in accordance with an example embodiment being illustrated. The example method 600 is provided by way of example, as there are a variety of ways to carry out the method. The method 600 described below can be carried out using the configurations illustrated in FIGS. 1 to 3, for example, and various elements of these figures are referenced in explaining example method 600. Each block shown in FIG. 6 represents one or more processes, methods or subroutines, carried out in the exemplary method 600. Additionally, the illustrated order of blocks is by example only and the order of the blocks can change. The exemplary method 600 can begin at block 602.

At block 602, a transmission module in a client device sends a request for a destination file to a master server. The destination file can be a media file, an image file, a text file, and so on.

At block 604, the transmission module receives a distribution form from the master server. The distribution form records an ID, a size, and a distributed encoding server of each of the file segments of the destination file. The ID of a file segment is distributed according to its position of the file segment within the destination file.

At block 606, the transmission module receives file segments that have been encoded from the encoding servers, and a decoding module in the client device decodes the file segments. The encoding servers can include the master server and can communicate with the client device using networks, such as the Internet, intranets, or any other suitable networks.

At block 608, an integration module in the client device integrates the file segments to generate a complete the destination file according to information in the distribution form. In one embodiment, the integration module integrates the file segments to generate the complete destination file according to the IDs of the file segments. As mentioned above, the IDs indicate positions of the file segments within the destination file.

At block 610, an outputting module in the client device outputs the complete destination file to a display device of the client device.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A distributed encoding method, the method comprising:
receiving, by a master server, a request of a destination file from a client device;
selecting, by the master server, source servers each of which stores the destination file;
computing, by the master server, priorities of the source servers;
selecting, by the master server, encoding servers from the source servers according to the priorities;
segmenting, by the master server, the destination file in each of the encoding servers into a plurality of file segments;
distributing, by the master server, the file segments to the encoding servers;
performing data encoding, by each of the encoding servers, to encode one or more distributed file segments distributed to the each of the encoding servers; and
transmitting, by the encoding servers, the file segments that have been encoded to the client device.

2. The method according to claim 1, wherein priorities of the source servers are computed using a formula P=QoS/Overhead, wherein the “P” represents a priority of one of the source servers, the “QoS” represents quality parameters of a network that connects the client device and the source server, the “Overhead” represents resources that the source server has consumed, and the symbol “/” is a division symbol that represents a division operation between QoS and Overhead.

3. The method according to claim 2, wherein the quality parameters of the network comprise packets transmitted between source server and the client device, network traffic, and/or network speed, and the resources including a memory usage and/or CPU utilization that the source server has consumed.

4. The method according to claim 1, wherein the file segments are distributed to the encoding servers according to a Round-Robin method.

5. The method according to claim 1, wherein the file segments are directly transmitted to the client device simultaneously or according to a predetermined order, or the file segments are transmitted to the master server firstly, and then, the master server transmits all of the file segments to the client device simultaneously or according to a predetermined order.

6. The method according to claim 1, the method further comprising:
recording an ID, a size, and a distributed encoding server of each of the file segments into a distribution form, wherein the ID of a file segment is distributed according to its position of the file segment in the destination file; and
performing synchronization of the distribution form between each of the encoding servers and the client device.

7. The method according to claim 6, further comprising a distributed decoding method that comprising:
receiving, by the client device, the file segments that have been encoded from the encoding servers, and decoding the file segments; and
integrating the file segments to generate the destination file according to the IDs of the file segments recorded in the distribution form.

8. A server cluster, each server in the server cluster comprising:
a control device; and
a storage device storing one or more programs which when executed by the control device, causes the control device to:
receive a request of a destination file from a client device that communicates with the server cluster;
select source servers from the server cluster each of which stores the destination file;
compute priorities of the source servers;
select encoding servers from the source servers according to the priorities;
segment the destination file in each of the encoding servers into a plurality of file segments;
distribute the file segments to the encoding servers;
perform data encoding to encode one or more distributed file segments distributed to the encoding servers; and
transmit the file segments that have been encoded to the client device.

9. The server cluster according to claim 8, wherein priorities of the source servers are computed using a formula P=QoS/Overhead, wherein the “P” represents a priority of one of the source servers, the “QoS” represents quality parameters of a network that connects the client device and the source server, the “Overhead” represents resources that the source server has consumed, and the symbol “/” is a division symbol that represents a division operation between QoS and Overhead.

10. The server cluster according to claim 9, wherein the quality parameters of the network comprise packets transmitted between source server and the client device, network traffic, network speed, and the resources include a memory usage or CPU utilization that the source server has consumed.

11. The server cluster according to claim 8, wherein the file segments are distributed to the encoding servers according to a Round-Robin method.

12. The server cluster according to claim 8, wherein the file segments are directly transmitted to the client device simultaneously or according to a predetermined order, or the file segments are transmitted to the master server firstly, and then, the master server transmits all of the file segments to the client device simultaneously or according to a predetermined order.

13. The server cluster according to claim 8, wherein the one or more programs when executed by the control device further causes the control device to:
record an ID, a size, and a distributed encoding server of each of the file segments into a distribution form, wherein the ID of a file segment is distributed according to its position of the file segment in the destination file; and
perform synchronization of the distribution form between each of the encoding servers and the client device.

14. A client device, comprising:
a display device;
a control device; and
a storage device storing one or more programs which when executed by the control device, causes the control device to:
send a request of a destination file to a master server;
receive file segments of the destination file that have been encoded from encoding servers which communicate with the client device using a network;
decode the file segments;
integrate the file segments to generate the destination file; and
output the destination file to the display device

15. The client device according to claim 14, wherein the one or more programs when executed by the control device further causes the control device to:
receive a distribution form from the master server, wherein the distribution form records an ID, a size, and a distributed encoding server of each of the file segments of the destination file.

16. The client device according to claim 15, wherein the ID of a file segment is distributed according to its position of the file segment in the destination file.

17. The client device according to claim 16, wherein the file segments are integrated to generate the destination file according to the IDs of the file segments.
